(19) United States
(12) Patent Application Publication
(10) Pub. No.: US 2013/0062230 A1
(43) Pub. Date: Mar. 14, 2013

(54) FASHION ADHERENCE ARTICLES AND A KIT INCLUDING A MULTIPLICITY OF FASHION ADHERENCE ARTICLES

(71) Applicant: Shannon Leigh Mattingly, Los Angeles, CA (US)

(72) Inventor: Shannon Leigh Mattingly, Los Angeles, CA (US)

(21) Appl. No.: 13/231,540

(22) Filed: Sep. 13, 2011

(51) Int. Cl. B65D 69/00; B32B 3/00; B65D 65/28; B32B 3/26

(52) U.S. Cl. 206/223; 428/304.4; 428/220; 428/43

(57) ABSTRACT

A foam fashion tape product with a polymer adhesive on both sides of the foam substrate providing temporary adhesion of fabric-to-fabric or fabric-to-skin with flexibility for movement with skin and fabric, and removable, leaving no adhesive residue behind.

### BACKGROUND OF THE INVENTION

1. Field of the Invention

The present invention relates to double-sided adhesive tapes for removable use on clothing and/or skin.

2. Description of the Prior Art

Prior art is known to provide removable, double-sided adhesive tapes for use on clothing. It is also known in the relevant art to provide a heat-fusible adhesives and their use in clothing; and also, generally, it is known to use double-sided adhesives, such as double-sided adhesives for use in automotive, electronics, carpeting, and home décor applications, including removable, foam-based, double-sided adhesives that appear to be primarily directed towards mounting of objects, such as pictures, on planar surfaces, such as walls. By way of example of relevant prior art documents:

US Pub. No. 20100018082 for Double-sided adhesive retainer for footwear; Inventors: Stokes, Dawn; describes device for footwear or other apparel comprising: a core having a first side and a second side; a first adhesive applied to the first side of the core; a second adhesive applied to the second side of the core; wherein the first adhesive is configured to removably adhere to the inside of footwear and the second adhesive is configures to removably adhere to a user's foot or ankle, and further describing that the core comprises a flexible cushion material such as a polyurethane foam.

U.S. Pat. No. 5,125,995—Method of using a water-dispersible pressure sensitive adhesive tape on cloth body coverings; Assignee: 3M; Inventors: D'Haese, Francois C.; Bischof, Katharina J.; Brink, Peter; et al.; describing a method of using a water-dispersible pressure sensitive adhesive tape for a cloth body covering to adhere cloth to cloth or mammalian skin, and that the adhesive material is coated on one or both sides of a water-dispersible substrate, such as a thin tissue paper, including that the tape is moisture resistant during use but is water dispersible in conditions as would be present during laundering, and that the cloth body covering may be a garment, a diaper, a gown, or a surgical drape or dressing.

US Pub. No. 20070054081—Double-sided adhesive anchoring device for a garment; Assignee: Not Listed; Inventors: DeMarco, Jill R.; describes an anchoring device for temporary adherence of an edge of a garment to a wearer, the device comprises: a fabric substrate with a garment side and a wearer side; a first adhesive on the garment side of the fabric substrate; a second different adhesive on the wearer side of the substrate; wherein the first adhesive is for anchoring the device to the garment and the second adhesive is for adhering the device to the skin of the wearer; and it further describes that the device may be used along a neckline of a blouse, top or dress, or along the leg hole of an underpant or swimsuit bottom to hold the clothing against the wearer and that the fabric adhesive is a semi-permanent acrylic-based adhesive for attaching the anchoring device to the garment for several wearings, and the skin adhesive may be detached from a wearer's skin without the use of solvents and is reuseable for the next wearing of the garment.

U.S. Pat. No. 5,177,482 & U.S. Pat. No. 6,211,263—Adhesive for secure topical attachment to the skin and comfortable removal; Assignee: The Procter and Gamble Company; Inventors: Cinelli, Fabio; Coles, Peter; and Corzani, (talo; describes a substrate with a topical adhesive applied thereon designed for attachment of protective articles, clothing, prosthesis, heat wraps, etc., to the skin, and use on clothing such as bras, surgical gowns, or parts of garments during fitting at a tailor, and further describes stiffness, viscous modulus, and elastic modulus characteristics of the substrate and/or adhesive.

U.S. Pat. No. 6,060,408—Double sided adhesive useful as clothing retaining means; Assignee: Creative Football Concepts, Inc.; Inventors: Monica; Mark D.; describes a double sided adhesive element for securing an article of clothing, such as a sports jersey, to protective padding, comprising: a flexible support member having a first side coated with an adhesive; and a second side coated with said adhesive; wherein said adhesive element has a shape adapted to cover and conform to a shape of a protective pad.

U.S. Pat. No. 5,516,581—Removable adhesive tape; Assignee: 3M; Inventors: Kreckel, Karl W; Hager, Patrick J.; and Rickert, James H.; the document describing a tape with a plastic backing with at least one major surface having a pressure sensitive adhesive, and the plastic backing possibly further including a layer of polymeric foam, wherein the tape may be double-sided, having adhesive on both major surfaces. The patent further describes Young's modulus, tensile strength, and elastic recovery of the plastic backing and the use of this tape in mounting and joining applications, namely and specifically mounting wall hangings.

U.S. Pat. No. 6,231,962—Removable foam adhesive tape; Assignee: 3M; Inventors: Bries, James L.; Hamerski, Michael D.; describing a pressure sensitive adhesive tape comprising a backing and a layer of a pressure-sensitive adhesive coated on at least one surface of the backing, and that the backing is a polymeric foam with a thickness of at least about 30 mils, that the tape may double-sided and have 2 surfaces coated with adhesive, and that the tape is removable and can be removed from the surface to which it has previously been attached without leaving residue on the surface. Specifically, this patent document describes the use of this tape in mounting and joining applications, such as mounting a picture to a surface such as a wall. U.S. Pat. Nos. 6,403,206 and 7,781,056 describe similar adhesive tapes.

### SUMMARY OF THE INVENTION

The present invention relates to double-sided adhesive fashion tape for temporary use on clothing and/or skin.

It is an object of this invention to provide an industrial grade foam fashion tape with a polymer adhesive on both sides of the foam substrate providing temporary adhesion of fabric-to-fabric or fabric-to-skin with flexibility for movement with skin and fabric, and removable, leaving no adhesive residue behind. Exemplary applications for embodiments of the present invention include to close the gap in button up shirt; hem pants and skirts; fix button; hold strapless/one strap dress up; fix a tie; replace collar stays; conceal bra/bra straps; keep a low cut shirt on without exposing more skin than desired.

Yet another object of this invention is to provide methods for securing clothing temporarily to skin using an industrial grade foam fashion tape with a polymer adhesive on both sides of the foam substrate.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1A and FIG. 1B a perspective view of one embodiment of the invention in one application.

FIG. 2 is a perspective view of another embodiment of the invention in one application.

FIG. 3 is a perspective view of one embodiment of the invention in one application.

FIG. 4 is a perspective view of another embodiment of the invention with partially removed adhesive coverings.

FIG. 5A illustrates a perspective view of a fashion tape article according to one embodiment of the present invention (shown in FIG. 4); FIG. 5B illustrates a front view of the article in FIG. 5A; FIG. 5C shows a side view of the article in FIG. 5A.

FIG. 6A illustrates a perspective view of one embodiment of a kit including fashion tape according to the present invention, in a partially open position.

FIG. 6B illustrates a top view of the embodiment in FIG. 6A in an open position. FIG. 6C illustrates a front view of the embodiment of FIG. 6A in an open position.

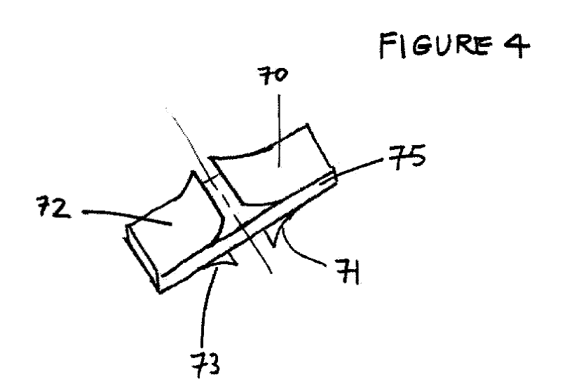

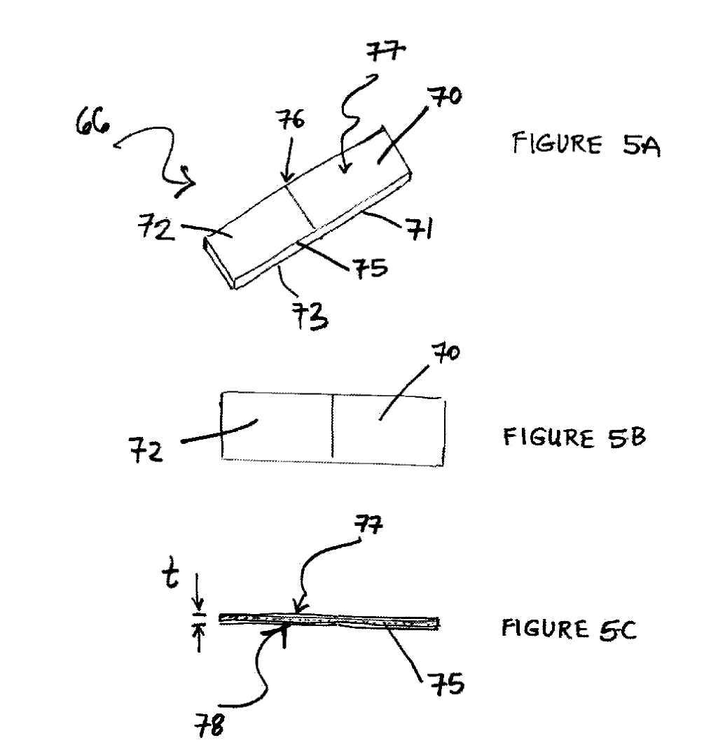

FIG. 5A illustrates a perspective view of a fashion tape article according to one embodiment of the present invention (shown in FIG. 4); FIG. 5B illustrates a front view of the article in FIG. 5A; FIG. 5C shows a side view of the article in FIG. 5A.

### DETAILED DESCRIPTION

Referring now to the drawings in general, the illustrations are for the purpose of describing a preferred embodiment of the invention and are not intended to limit the invention thereto.

While it is known in the prior art documents to describe removable, double-sided adhesive tapes with clothing applications, the tapes described therein introduce problems with their application to clothing, including lack of easy intended removability after usage or intended useful predetermined time of application, often leaving marks or adhesive residue on clothing or skin; the tape may not adequately adhere to the clothing surface, so it fails to maintain the clothing material in the desired location during use of the garments; and/or the tape does not have adequate flexibility to conform to the fabric movement when the clothing is worn, either detaching (not maintaining adherence), or deforming the material and clothing during use.

The present invention provides an industrial grade foam fashion tape with a polymer adhesive on both sides of the foam substrate providing temporary adhesion of fabric-to-fabric or fabric-to-skin with flexibility for movement with skin and fabric, and removable, leaving no adhesive residue behind. Exemplary applications for embodiments of the present invention include to close the gap in button up shirt; hem pants and skirts; fix button; hold strapless/one strap dress up; fix a tie; replace collar stays; conceal bra/bra straps; keep a low cut shirt on without exposing more skin than desired.

In considering the present invention with respect to the known prior art of relevance to it, several characteristics were identified as being relevant to distinguishing the present invention over prior including consideration of the longstanding, unmet need in the prior art to provide a foam-based, removable and double-sided adhesive product applicable to clothing to provide a non-marking adherence, including the following factors: color, thickness, compressibility, elasticity, etc. of the tape; tape substrate and composition (foam, plastic film, textile, etc.); permanence (removable, semi-permanent, permanent); composition of adhesive material; and application or industry of use, since the requirements and performance issues vary significantly in different applications.

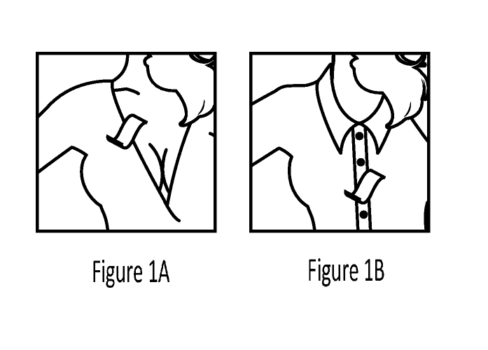

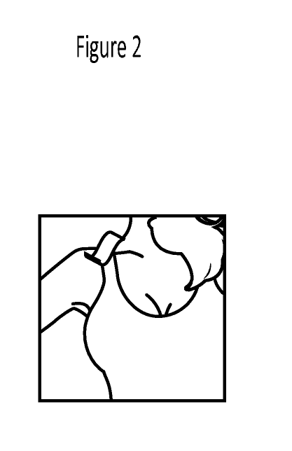

The first figures illustrate the adhesive article or product in application or use on a woman's clothing and/or skin. FIG. 1A and FIG. 1B a perspective view of one embodiment of the invention in one application, more specifically, FIG. 1A is directed at positioning inside the V-neck collar of a woman's dress, applying the adhesive on one side to the dress and on the other side to the skin at a corresponding location where the dress surface would naturally drape or fall onto the chest, and FIG. 1B illustrates application of the adhesive article at a shoulder strap location, once again intended to be applied under the shoulder strap applied on one side to the inner face of the strap and on the other side to the skin, preferably at the location where the user prefers that the strap remain in place without moving or falling off the shoulder. FIG. 2 is a perspective view of another embodiment of the invention in one application, illustrating the application of the adhesive product in a material-to-material application wherein the strip of double-sided foam adhesive is applied in a substantially vertically aligned manner in the gap region between the buttons/buttonholes that are spaced-apart; the application of the present invention in this manner prevents gapping or opening in those regions between the spaced-apart buttons, thus keeping the entire button region closed securely, until the removable adhesive foam is removed. Advantageously, the flexibility of the foam allows for movement and flex without releasing prematurely, especially given the tension naturally occurring when the shirt wearer moves, and the regions between the spaced-apart buttons would naturally give, causing a gap without the application of the product according to the present invention.

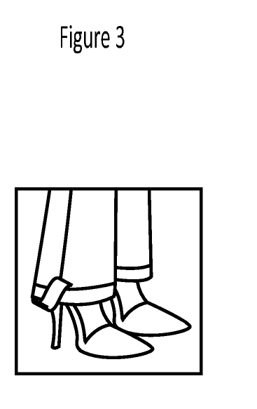

FIG. 3 is a perspective view of one embodiment of the invention in one application, wherein the product is applied in a material-to-material manner, this time on a hemline. This provides for a temporary but secure hem to be held in place, ensuring that a multiplicity of the adhesive product according to the present invention may be applied in a spaced-apart manner around the circumference of the pant leg hem area to provide a complete and even hem. The dimensions and the foam material, including thickness, provides for the most secure material-to-material adherence without marking when the product is removed from the garment.

FIG. 4 is a perspective view of another embodiment of the invention with partially removed adhesive coverings. FIG. 5A illustrates a perspective view of a fashion tape article according to one embodiment of the present invention (shown in FIG. 4); FIG. 5B illustrates a front view of the article in FIG. 5A; FIG. 5C shows a side view of the article in FIG. 5A. As illustrated in FIG. 4 and in FIGS. 5A, 5B, and 5C, the preferred embodiment flexible, double-sided adhesive foam article, generally referenced 66, has two equally sized removable protective strips covering the adhesive surface of the foam on each side: two protective strips (70, 72) on the top surface 77 and two protective strips (71, 73) on the bottom surface 78 aligned and juxtapositioned at central dividing line 76. The top surface 77 and bottom surface 78 both have an adhesive applied thereon and are spaced apart by the foam body member 75 having a thickness (t), shown in FIG. 5C. The protective strips are removably attached to and covering the adhesive surfaces of the article, and may be peeled away as illustrated in FIG. 4 at the time of application.

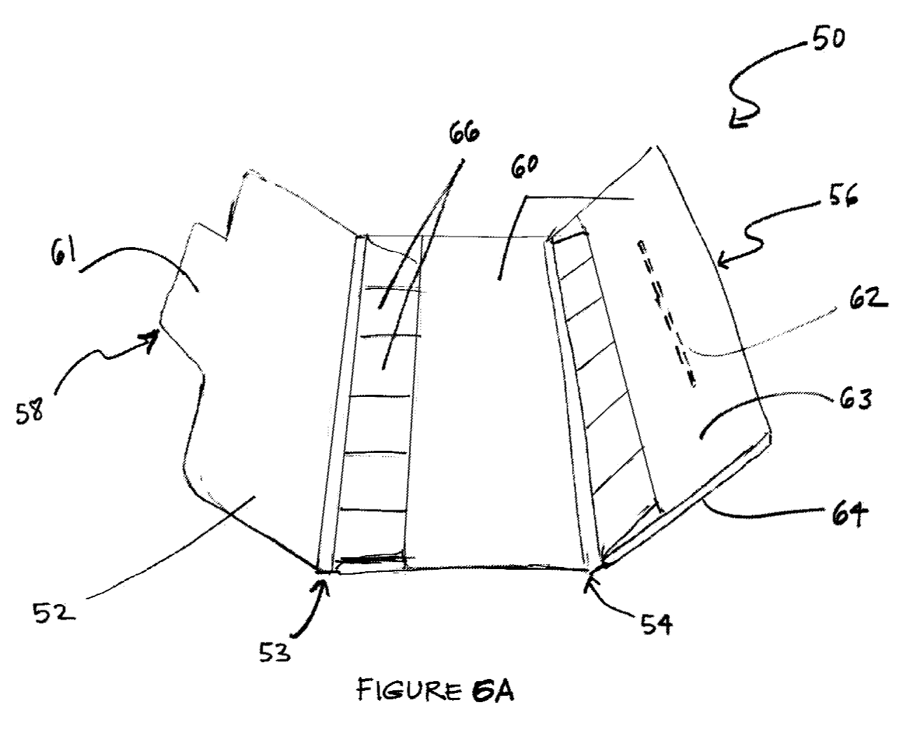

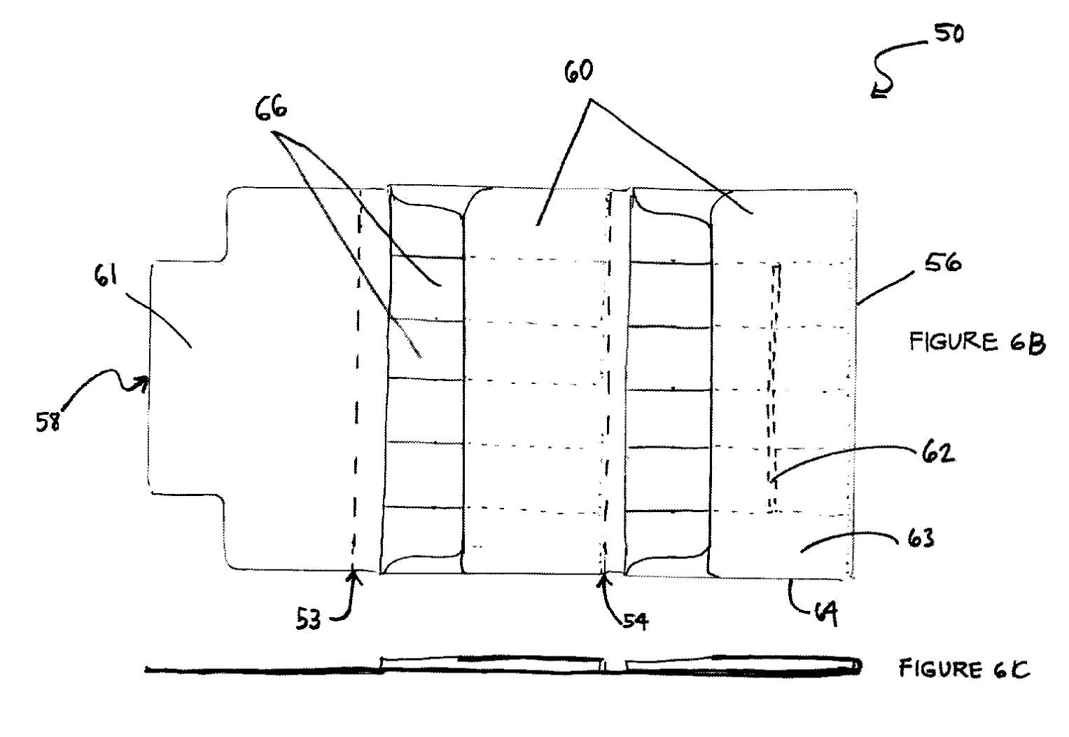

FIG. 6A illustrates a perspective view of one embodiment of a kit, generally referenced 50, including a multiplicity of fashion tape articles (each labeled 66) that are selectively removable from the kit housing including at least one, but preferably two pockets 60 that are sized, constructed and configured to securedly and releasably receive and hold the multiplicity of articles; the kit according to the present invention is movable between open and closed positions, and is shown in a partially open position for accessing the fashion tape articles 66. The housing includes two opposing ends 56, 58 that fold over a central portion at fold lines 53, 54 so that corresponding inside surfaces 63 and 52 rotationally fold toward the central region including one of the at least one receiving pocket 60. Preferably, the lower end 56 folds over line 54 first to move the kit into the closed position from the open position, such that face side 64 is exposed when surface 63 faces downward. This also exposes opening 62 that is sized, shaped, and configured for receiving end tab 61 to retain the top end 58 when the kit is in the closed position. As illustrated, and in preferred embodiments, the kit is sized, shaped, configured and constructed with two pockets for holding six articles in a single row in each pocket, but more preferably, two stacked rows of six articles in each pocket. Correspondingly, FIG. 6B illustrates a top view of the embodiment in FIG. 6A in an open position. FIG. 6C illustrates a front view of the embodiment of FIG. 6A in an open position. As shown in FIG. 6B, wherein the kit is shown in a completely open position, any of the multiplicity of articles may be selectively removed from either of the two pockets by slidingly removing one article from the exposed article end, near the fold lines 53 and 54. As illustrated in FIGS. 6A, 6B, and 6C, a kit including a package or housing for enclosing a multiplicity of foam-based, removable and double-sided adhesive product components (or adhesive articles) applicable to clothing and/or skin to provide a non-marking adherence are illustrated, with each product component or adhesive article being individually presented in the preferred dimensions set forth hereinabove, and being sealed for application upon removal of the adhesive protective covering strip on each face of the product.

As set forth hereinabove, FIG. 5A illustrates a perspective view of a fashion tape article according to one embodiment of the present invention (shown in FIG. 4); FIG. 5B illustrates a front view of the article in FIG. 5A; FIG. 5C shows a side view of the article in FIG. 5A. More particularly, regarding FIGS. 4, and FIGS. 5A-5C, the foam-based, removable and double-sided adhesive product applicable to clothing and/or skin to provide a non-marking adherence of the present invention is shown. Preferred dimensions are between about 4.5 and about 5.5 cm in length and between about 1.0 to about 1.6 cm in width; more preferably between about 5.0 and about 5.3 cm in length and between about 1.0 and about 1.5 cm width. Also, width of about 1.4 cm is another preferred embodiment. The thickness is preferably about 0.10 cm. In one embodiment, the article is about 15 mm by about 52 mm These dimensions provide optimum flexibility and application security of adhesion between clothing-to-skin and/or material-to-material.

Importantly, and in distinction from any prior art known, including any other “fashion tape” commercially available as of the date of the present invention, the article of the present invention is provided in strip form in one embodiment, as set forth hereinabove, but it is constructed to be modifiable in size and shape, i.e., the material can be reduced in size by intentionally ripping or tearing it across the width. This feature and functionality is important because use of the present invention article can be under urgent or unexpected circumstances where no scissors or cutting instrument is available to change the size or shape of the article. The foam article also provides for flexibility and stretch.

By way of example from specific prototype embodiments, the following Table 1 illustrates sample properties:

TABLE 1

| Foam Type | | Polyethylene |
|---|---|---|
| Adhesive Type | | Rubber |
| Adhesive Family | | 710 (R-10) |
| Thickness | Nominal | 0.042 in |
| | Tolerance | 0.030-0.054 |
| Color | | White, Nude, or Black |
| Release Liner | | 0.003 in printed paper |
| Approximate | Lb/Ft³ | 12 |
| Density (Foam Only) | Kg/cm³ | 192 |

| | |
|---|---|
| Peel Adhesion | 6 lbs./in. width |
| Stainless Steel, Room | (105 N/100 mm) |
| Temperature, 90° Angle | |
| Peel, 12 in./minute Jaw | |
| Speed (308 mm/min), 72 | |
| hour Dwell (ASTM D- | |
| 3330) | |
| Static Shear Strength | 1000 at 72° F. (22° C.) |
| ½ in.² (1.6 cm²) overlap Will | |
| hold listed gram weight for | |
| 10,000 minutes (ASTM D- | |
| 3654) | |
| T-Block | 95 lbs. (43 Kg) |
| Aluminum, Room | |
| Temperature 1.0 in.2, 2.0 in./min. | |
| Jaw Speed ASTM | |
| D-897 | |
| Dynamic Shear | 100 lbs. (45 kg) |
| Stainless Steel, Room | |
| Temperature 1.0 in.2 | |
| overlap, 0.5 in./min Jaw | |
| Speed ASTM D-1002 | |
| Temperature Resistance | 105° F. (41° C.) |

| | |
|---|---|
| U.V. Resistance | Not recommended for direct |
| | exposure to U.V. light |
| Solvent Resistance | No apparent degradation when |
| | exposed to splash testing of |
| | most hydrocarbon solvents |
| Shelf Life | 18 months from the date of |
| | manufacture when stored in original |
| | cartons at 70° F. (21° C.) |
| | and 50% relative humidity |

Also, by way of test data of a prototype of an embodiment of the present invention, for adherence strength on fabric shown in Table 2 and Table 3, the following is provided in comparison with known prior art commercial products:

Below are the results of two tests to compare an embodiment of the present invention to other fashion tape type products on the market to show strength of adhesion in application to the material shown (i.e., removably affixing the product to keep two layers of material in a predetermine relationship with the fashion tape. All the results are averages of multiple test runs on each product sample. “Style Snaps” products are not included in the performance percentages because they could not be properly compared to the present invention with the testing procedure used on the material indicated.

Table 2 (Below).

Material: Silky Polyester

| | Hollywood Fashion | | |
|---|---|---|---|
| Present Invention | Tape | Victoria's Secret | Matchsticks |
| 8.2 kg | 3.3 kg | 3.2 kg | 3.45 kg |

On average the present invention product outperformed the competitors by 68%.

Table 3 (Below).

Material: Cotton

| | Hollywood Fashion | | |
|---|---|---|---|
| Present Invention | Tape | Victoria's Secret | Matchsticks |
| 7.7 kg | 2.78 kg | 2.95 kg | 2.78 kg |

On average the present invention product outperformed the competitors by 58%.

Certain modifications and improvements will occur to those skilled in the art upon a reading of the foregoing description. By way of example but not limitation, colorization of the foam-based article is preferably black or nude to suitably be used with most clothing options. Another colorization preference would be “invisible” or colorless. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

What is claimed is:

1. A fashion tape article comprising: a foam-based, double-sided adhesive product applicable to clothing and to human skin, wherein the adhesive product provides a non-marking adherence when selectively removed.

2. The article of claim 1, wherein the foam-based, double-sided adhesive product includes dimensions that are between about 4.5 and about 5.5 cm in length and between about 1.0 to about 1.5 cm in width, with the thickness being about 0.10 cm for providing flexible secure attachment.

3. The article of claim 1, wherein the foam-based, double-sided adhesive product includes dimensions that are between about 5.0 and about 5.3 cm in length and between about 1.0 and about 1.4 cm width, with the thickness being about 0.10 cm for providing flexible secure attachment.

4. The article of claim 1, wherein the product includes polyurethane foam.

5. The article of claim 1, wherein the product is tearable or rippable across a width dimension.

6. A kit including fashion tape articles comprising:
a multiplicity of fashion tape articles that are selectively removable from the kit housing including at least one pocket inside the housing that is sized, constructed and configured to securedly and releasably receive and hold the multiplicity of articles;
wherein each of the fashion tape articles includes adhesive surface on each of two opposite sides that are completely covered by an adhesive protective covering strip on each side; and wherein the adhesive protective covering is removable to expose the adhesive after removal of the fashion tape article from the housing.

7. The kit according to claim 6, wherein the housing includes two pockets.

8. The kit according to claim 6, wherein the articles are slidingly removable from the housing pockets.

9. A kit including fashion tape articles comprising:
a multiplicity of fashion tape articles that are selectively removable from the kit housing including at least one pocket inside the housing that is sized, constructed and configured to securedly and releasably receive and hold the multiplicity of articles;
wherein each of the fashion tape articles includes adhesive surface on each of two opposite sides that are completely covered by an adhesive protective covering strip on each side;
wherein each side has two equally sized removable protective strips covering the adhesive surface of the foam on each side; and
wherein the adhesive protective covering is removable to expose the adhesive after removal of the fashion tape article from the housing.

10. The kit of claim 9, wherein the kit housing further includes an end tab and an opening to retain the end tab when the kit is in the closed position.

11. The kit of claim 9 includes two stacked rows of six articles in each pocket.
